(19) United States
(12) Patent Application Publication
(10) Pub. No.: US 2008/0071006 A1
(43) Pub. Date: Mar. 20, 2008

(54) Solid, non-expanded, filled elastomeric molded parts and a process for the preparation thereof

(76) Inventors: Eva Emmrich, Essen (DE); Klaus Brecht, Burscheid (DE); Uwe Pfeuffer, Leverkusen (DE)

Correspondence Address: BAYER MATERIAL SCIENCE LLC, 100 BAYER ROAD, PITTSBURGH, PA, 15205, US

(21) Appl. No.: 11/895,926

(22) Filed: Aug. 28, 2007

(30) Foreign Application Priority Data
Aug. 30, 2006 (DE) 10 2006 040 504.8

(51) Int. Cl. C08G 18/28

(52) U.S. Cl. 523/167; 524/875

(57) ABSTRACT

The invention provides solid, non-expanded, filled, molded parts which comprise an elastomeric polyurethane. This invention is also directed to a process for the production of these molded parts to the use thereof.

### CROSS REFERENCE TO RELATED PATENT APPLICATION

The present patent application claims the right of priority under 35 U.S.C. §119 (a)-(d) of German Patent Application No. 10 2006 040 504.8, filed Aug. 30, 2006.

### BACKGROUND OF THE INVENTION

The invention provides solid, non-expanded, filled, molded parts that comprise an elastomeric polyurethane. It also provides a process for the preparation of these solid, non-expanded, filled, molded parts of elastomeric polyurethane, and the use thereof.

Solid, transparent polyurethane (PUR) elastomers have been known for a long time and are, with appropriate adjustment, suitable for use in a wide variety of applications. Polyurethane gels as described in, for example, DE-A 100 24 097, are mentioned in particular here.

In general, polyurethane gels are transparent materials with a high specific weight. They are characterised by special mechanical properties such as e.g. good shock absorption. This viscoelastic behavior is expressed especially well in thin layers. As an example, heel-cushion pads comprising these PUR gels may be mentioned here. However, if the layer is too thick, it is observed that the energy take-up of the material is very high. Low damping behaviour is, however, more beneficial, particularly in this end-use application, for physiological reasons. [See Dissertation Walther M., Zusammenhänge zwischen der subjektiven Beurteilung von Laufschuhen, den Materialdaten, sowei kinetischen und kinematischen Parametern des Gangzyklus, University of Würzburg, 2001].

Another disadvantage of these shape-stable gels comprises their production. In this case, a long-chain polyol is reacted with a polyisocyanate with a low index. As a result of this so-called undercuring, the required processing times are too long. In addition, the molded item has a tacky surface. This requires the gels to be covered with different types of coatings in an additional working step in order to obtain a tack-free surface.

In order to lower the specific density of solid PUR materials and also of PUR gels, frequent use is made of specific, relatively light fillers. These light fillers include, for example, fillers such as cork granules, decorative metal flakes, polyurethane granules or flocks, textile fibers such as e.g. sisal, textile fragments, expanded materials such as e.g. EVA (ethyl vinyl acetate), or else specific relatively heavy fillers such as e.g. leather pellets, or else expanded rubber (TR=thermoplastic rubber). Depending on the filler used, the density of these molded parts is lower or higher, but preferably lower. In the case of PUR gels, the incorporation of fillers is also used due to the attractive optics of the molded part. Furthermore, fillers are used in PUR materials in order to improve mechanical properties, in order to contribute to decreasing the material costs or to enable the recycling of raw materials that cannot be used in other ways.

The object of the present invention was to provide elastomeric polyurethane molded parts that do not have the disadvantages of PUR gels described above. The undesired disadvantages of the polyurethane molded parts include long demolding times, tacky surfaces and high damping behaviour. It is, however, desirable that these polyurethane molded parts have, simultaneously, an optically interesting and attractive exterior, and a specifically adjustable elasticity.

Surprisingly, the present object can be achieved by the elastomeric molded parts based on polyurethane as described herein.

### SUMMARY OF THE INVENTION

The present invention provides solid, filled, molded parts which comprise a polyurethane elastomer, in which the molded part has a rebound resilience of 20 to 60%, bubble-free optics and a tack-free surface. These polyurethane elastomers comprise the reaction product of
(A) a polyol formulation comprising:
   a) a polyol component comprising:
      a1) at least one polyether polyol having an OH number of from 20 to 112, a functionality of 2, containing ≧45% by weight of primary OH groups, and which is the alkoxylation product of a suitable initiator with propylene oxide and/or ethylene oxide;
      and
      a2) at least one polyether polyol having an OH number of from 20 to 112, a functionality of greater than 2 to 6, preferably 3 to 6, containing ≧45% by weight of primary OH groups, and which is the alkoxylation product of a suitable initiator with propylene oxide and/or ethylene oxide;
   b) one or more chain extenders and/or crosslinking agents which have an OH number in the range of from 600 to 2000;
   c) one or more catalysts;
   and, optionally,
   d) one or more additives;
with
(B) an isocyanate component;
in the presence of
C) from 10 to 40 wt.%, based on 100 wt.% of the filled polyurethane elastomer, of one or more fillers having a diameter of from 1 to 10 mm.

In addition, the equivalent ratio of isocyanate (NCO) groups in (B) said isocyanate component, to the sum of hydrogen atoms that can react with the isocyanate groups in components a), b) and c), ranges from 0.8:1 to 1.2:1, preferably 0.95:1 to 1.15:1, and most preferably from 0.98:1 to 1.05:1.

The invention also provides a process for producing the solid, filled, molded parts comprising the polyurethane elastomers, in which these molded parts have a rebound resilience of 20 to 60%, bubble-free optics and a tack-free surface. This process for producing these polyurethane elastomers comprises reacting
(A) a polyol formulation comprising:
   a) a polyol component comprising:
      a1) at least one polyether polyol having an OH number of from 20 to 112, a functionality of 2, containing ≧45% by weight of primary OH groups, and which is the alkoxylation product of a suitable initiator with propylene oxide and/or ethylene oxide;
      and
      a2) at least one polyether polyol having an OH number of from 20 to 112, a functionality of greater than 2 to 6, preferably 3 to 6, containing ≧45% by weight of primary OH groups, and which is the alkoxylation product of a suitable initiator with propylene oxide and/or ethylene oxide;
   b) one or more chain extenders and/or crosslinking agents which have an OH number in the range of from 600 to 2000;
   c) one or more catalysts;
   and, optionally,
   d) one or more additives;
with
(B) an isocyanate component;
in the presence of
C) from 10 to 40 wt. %, based on 100 wt. % of the filled polyurethane elastomer, of one or more fillers having a diameter of from 1 to 10 mm.

In addition, the equivalent ratio of isocyanate (NCO) groups in (B) said isocyanate component, to the sum of hydrogen atoms that can react with the isocyanate groups in components a), b) and c), ranges from 0.8:1 to 1.2:1, preferably 0.95:1 to 1.15:1, and most preferably from 0.98:1 to 1.05:1.

The process additionally comprises placing this reaction mixture in a mold and curing the reaction mixture for no more than 5 minutes.

### DETAILED DESCRIPTION OF THE INVENTION

In the present application, the rebound resilience is measured in accordance with DIN 53512.

Diisocyanates suitable for use in the present invention as (B) the isocyanate component include those diisocyanates known from polyurethane (PUR) chemistry, and preferably aromatic diisocyanates. In addition, prepolymers of isocyanates are suitable. In particular, isocyanate prepolymers which comprise the reaction product of (1) 4,4′-diphenylmethane diisocyanate and/or modified 4,4′-diphenylmethane diisocyanate, with (2) a mixture comprising (a) one or more polyether polyols having an OH number of from 10 to 112, and (b) one or more polyethylene glycols and/or polypropylene glycols having molecular weights of 135 g/mol to 700 g/mol, are particularly preferred. Suitable modified diisocyanates include, for examples, 4,4′-diphenylmethane diisocyanate which has been modified such that it includes carbodiimide groups and/or allophanate groups.

Suitable compounds to be used as components a1), a2), b), c) and d) in the polyol formulation (A) are well-known. These are compounds that are typically used in polyurethane chemistry.

If the molded part were to be prepared without a filler, the polyurethane would have a density in the range of from 1050 to 1200 kg/m³.

Suitable fillers to be used as component (C) in accordance with the present invention, include, for example, cork granules, leather pellets, decorative metal flakes, polyurethane granules, polyurethane flocks, textile fibers, such as e.g. sisal, textile fragments, expanded materials such as e.g. EVA (ethyl vinyl acetate), expanded rubber (TR=thermoplastic rubber) and glass fibers.

These solid, filled, elastomeric polyurethane molded parts are suitable for use as, for example, for industrial items and consumer items, and particularly as soles of shoes and as shoe inserts.

The invention is explained in more detail in the following examples.

The following examples further illustrate details for the process of this invention. The invention, which is set forth in the foregoing disclosure, is not to be limited either in spirit or scope by these examples. Those skilled in the art will readily understand that known variations of the conditions of the following procedures can be used. Unless otherwise noted, all temperatures are degrees Celsius and all percentages are percentages by weight.

### EXAMPLES

To produce the molded parts, the two components A (i.e. the polyol formulation) and B (i.e. the isocyanate component) were blended together using a screw (i.e. Klöckner Desma, Achim). The filler, component (C), was metered into this reaction mixture. The reaction mixture comprising polyol, filler and isocyanate was placed in an open mold and cured.

More specifically, component (A) with a material temperature of 30° C. was blended with component (B) the NCO prepolymer, in which the material temperature was also 30° C. The filler, component (C), was added to this reaction mixture. The mixture was placed in an aluminum hinged mold (size 200×70×10 mm), that was preheated to 50° C., and the hinged mold was closed. The molded part was demolded after a few minutes.

The Shore A hardness of the molded items produced in this way was determined, in accordance with DIN 53505 after being stored for 24 h. The rebound resilience was also determined, in accordance with DIN 53512. Furthermore, indentation tests were performed on the molded parts, in accordance with DIN 53579, number IV.

The experimental results are summarised in Table 1 below.

Starting Materials:

Polyetherpolyols:

1) A mixture of tripropylene glycol and a polyether polyol based on propylene oxide, in which the mixture has an OH number of 163.

2) A polyether polyol having an OH number of 28, which contains 70% propylene oxide and 30% ethylene oxide units with propylene glycol as the starter, and 90% primary OH groups.

3) A polyether polyol having an OH number of 56, which contains 86% propylene oxide and 14% ethylene oxide units with glycerine as the starter, and contains about 45% primary OH groups.

4) A polyether polyol having an OH number of 28, which contains 82% propylene oxide and 18% ethylene oxide units with sorbitol as the starter, and contains 85% primary OH groups.

5) A polyether polyol having an OH number of 27, which contains 78% propylene oxide and 22% ethylene oxide units with glycerine as the starter, and contains 90% primary OH groups.

6) A polyether polyol having an OH number of 56, which contains 40% propylene oxide and 60% ethylene oxide units with trimethylolpropane as the starter, and contains >90% primary OH groups.

Isocyanate Components:

1) A prepolymer having an NCO content of 19.8%, prepared by reacting 66 parts by wt. of 4,4′-diisocyanatodiphenylmethane (4,4′-MDI), 5 parts by wt. of modified 4,4′-MDI with a NCO content of 30% (that is prepared by partial carbodiimidisation), and 29 parts by wt. of polyetherpolyol 1).

2) A polymer-containing prepolymer having a NCO content of 31.5% (commercially available as Desmodur 44V10L from Bayer Material Science AG).

### Example 1

### According to the Invention

The polyol formulation (A) comprised:

3712.50 parts by wt. of the difunctional polyetherpolyol 2),

1125.00 parts by wt. of polyetherpolyol 3),

75.00 parts by wt. of Dabco in ethylene glycol,

25.00 parts by wt. of diethylene glycol,

50.00 parts by wt. of triethanolamine,

and

12.50 parts by wt. of dimethyl-bis-[(1-oxo-neodecyl)oxy]stannane.

100 parts by wt. of this polyol component (A) were blended with (B) 24 parts by wt. of prepolymer 1 and (C) 14 parts by wt. of cork granules having a particle size of 1 mm. (Isocyanate Index of the system was 98.)

### Example 2

### According to the Invention

The polyol formulation (A) comprised:

3712.50 parts by wt. of the difunctional polyetherpolyol 2),

1125.00 parts by wt. of polyetherpolyol 4),

75.00 parts by wt. of Dabco in ethylene glycol,

25.00 parts by wt. of diethylene glycol,

50.00 parts by wt. of triethanolamine,

and

12.50 parts by wt. of dimethyl-bis-[(1-oxo-neodecyl)oxy]stannane.

100 parts by wt. of this polyol component (A) were blended with (B) 25 parts by wt. of prepolymer 1 and (C) 14 parts by wt. of cork granules having a particle size of 1 mm. (Isocyanate Index of the system was 98.)

### Example 3

### Comparison

The polyol formulation (A) comprised:

4038.00 parts by wt. of the difunctional polyetherpolyol 2),

500.00 parts by wt. of polyetherpolyol 5),

350.00 parts by wt. of 1,4-butanediol,

25.00 parts by wt. of ethylene glycol,

2.50 parts by wt. of Dabco,

40.00 parts by wt. of Dabco blocked with 2-ethylhexanoic acid,

30.00 parts by wt. of triethanolamine,

1.50 parts by wt. of dibutyltin dilaurate,

3.00 parts by wt. of dibutyltin sulfide,

and

10.00 parts by wt. of water.

100 parts by wt. of this polyol component (A) were blended with (B) 48 parts by wt. of prepolymer 1 and (C) 5 parts by wt. of cork granules having a particle size of 1 mm. (Isocyanate Index of the system was 98.)

### Example 4

### Comparison

The polyol formulation (A) comprised

1000 parts by wt. of the trifunctional polyetherpolyol 6),

and

10 parts by wt. of Dabco in dipropylene glycol.

100 parts by wt. of this polyol component (A) were blended with (B) 5 parts by wt. of prepolymer 2 and (C) 15 parts by wt. of cork granules having a particle size of 1 mm. (Isocyanate Index of the system was 60.)

### Example 5

### Comparison

A polyol formulation (A) (polyether polyol 2), polyetherpolyol 3), Dabco in ethylene glycol and dimethyl-bis-[(1-oxo-neodecyl)oxy]stannane) was mixed with prepolymer 1.

Without a chain extender/crosslinking agent almost no reaction took place; the mixture stayed liquid and did not become solid. The use of another, stronger catalyst (tin catalyst UL-32) was not successful, the mixture stayed liquid.

### Example 6

### Comparison

A polyol mixture (10 parts by weight of a polyetherpolyol {OH number 36, functionality F=3, TMP as a starter, 20% ethylene oxide, 80% propylene oxide}, 40 parts by weight of a polyetherpolyol {OH number 56, F=2, PG as a starter, 100% propylene oxide}, 50 parts by weight of a polyetherpolyol {OH number 56, F=3, TMP as a starter, 55% ethylene oxide, 45% propylene oxide)) and Coscat 83 (catalyst) were mixed with Desmodur® N3400 from Bayer MaterialScience AG.

There was almost no reaction so that the mixture stayed liquid.

TABLE 1

| | Example | | | |
|---|---|---|---|---|
| | Example 1 | Example 2 | Example 3 | Example 4 |
| Hardness | 55/74 | 48/70 | 37/55 | 28/56 |
| [Shore A]/ | | | | |
| [Asker C] | | | | |
| Degree of filling | 15 | 15 | 5 | 15 |
| [wt. %] | | | | |
| Rebound | 40 | 41 | 34 | 29 |
| elasticity [%] | | | | |
| Rel. energy- | 0.24 | 0.31 | 0.23 | 0.33 |
| absorption ΔW* | | | | |
| Min. demolding | 3.5 | 3 | 4 | 5.5 |
| time [min]** | | | | |
| Optics/surface | transparent | transparent | milky | transparent |
| | dry | dry | dry | tacky |
| Deformation | 0.96 | 0.94 | 1.53 | 3.11 |
| [mm]*** | | | | |

*The energy-absorption ΔW is also called damping and was obtained by measuring the work done during loading of a sample in Newton and work during removal of the load from the sample, using the equation: ΔW = [W(loading) − W(removing load)]/W (loading)
**Minimum demolding time is the time required to be able to remove the molded part from the mold, without deformation, and for the surface to be no longer tacky.
***Deformation in mm is determined by applying a constant force of 150 N to the sample.

As can be seen from Table 1, Examples 1 and 2 according to the invention demonstrate
1) better demolding characteristics (i.e. shorter demolding time);
2) bubble-free optics with a dry, tack-free surface;
3) much less deformation and thus lower energy-absorption;
and
4) for almost the same hardness values, specifically adjustable values for rebound resilience.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A solid, filled, molded part comprising a polyurethane elastomer in which the molded part has a rebound resilience of 20 to 60%, bubble-free optics and a tack-free surface, wherein said polyurethane elastomer comprises the reaction product of
(A) a polyol formulation comprising:
a) a polyol component comprising:
a1) at least one polyether polyol having an OH number of from 20 to 112, a functionality of 2, containing ≧45% by weight of primary OH groups, and which is the alkoxylation product of a suitable initiator with propylene oxide and/or ethylene oxide;
and
a2) at least one polyether polyol having an OH number of from 20 to 112, a functionality of greater than 2 to 6, containing ≧45% by weight of primary OH groups, and which is the alkoxylation product of a suitable initiator with propylene oxide and/or ethylene oxide;
b) one or more chain extenders and/or crosslinking agents which has an OH number in the range of from 600 to 2000;
c) one or more catalysts;
and, optionally,
d) one or more additives;
with
(B) an isocyanate component;
in the presence of
(C) from 10 to 40 wt. %, based on 100 wt. % of the filled polyurethane elastomer, of one or more fillers having a diameter of from 1 to 10 mm;
in which the equivalent ratio of isocyanate (NCO) groups in (B) said isocyanate component, to the sum of hydrogen atoms which can react with isocyanate groups in components a), b) and c) ranges from 0.8:1 to 1.2:1.

2. The solid, filled, molded part of claim 1, in which the equivalent ratio of isocyanate (NCO) groups in (B) said isocyanate component, to the sum of hydrogen atoms which can react with isocyanate groups in components a), b) and c) ranges from 0.95:1 to 1.15:1.

3. The solid, filled, molded part of claim 1, in which the equivalent ratio of isocyanate (NCO) groups in (B) said isocyanate component, to the sum of hydrogen atoms which can react with isocyanate groups in components a), b) and c) ranges from 0.98:1 to 1.05:1.

4. The solid, filled, molded part of claim 1, in which (B) said isocyanate component comprises a prepolymer prepared by reacting (1) 4,4′-diphenylmethane diisocyanate and/or modified 4,4′-diphenylmethane diisocyanate, with (2) a mixture comprising (a) one or more polyether polyols having an OH number of from 10 to 112, and (b) one or more polyethylene glycols and/or one or more polypropylene glycols having molecular weights of 135 g/mol to 700 g/mol.

5. The solid, filled, molded part of claim 4, in which the modified 4,4′-diphenylmethane diisocyanate additionally contains carbodiimide groups and/or allophanate groups.

6. A process for producing a solid, filled, molded parts comprising a polyurethane elastomer in which the molded part has a rebound resilience of 20 to 60%, bubble-free optics and a tack-free surface, and which comprises reacting
(A) a polyol formulation (A) comprising:
a) a polyol component comprising
a1) at least one polyether polyol having an OH number of from 20 to 112, a functionality of 2, containing ≧45% by weight of primary OH groups, and which is the alkoxylation product of a suitable initiator with propylene oxide and/or ethylene oxide;
and
a2) at least one polyether polyol having an OH number of from 20 to 112, a functionality of greater than 2 to 6, containing ≧45% by weight of primary OH groups, and which is the alkoxylation product of a suitable initiator with propylene oxide and/or ethylene oxide;
b) one or more chain extenders and/or crosslinking agents which has a OH number in the range of from 600 to 2000;
c) one or more catalysts;
and, optionally,
d) one or more additives;
with
(B) an isocyanate component;
in the presence of
(C) from 10 to 40 wt. %, based on 100 wt. % of the filled polyurethane elastomer, of one or more fillers having a diameter of from 1 to 10 mm;
placing the reaction mixture of components (A), (B) and (C) into a mold, and curing the reaction mixture for no more than 5 minutes; wherein in the reaction mixture the equivalent ratio of isocyanate (NCO) groups in (B) said isocyanate component, to the sum of hydrogen atoms that can react with isocyanate groups in components a), b) and c) ranges from 0.8:1 to 1.2:1.

7. The process of claim 6, in which the equivalent ratio of isocyanate (NCO) groups in (B) said isocyanate component, to the sum of hydrogen atoms which can react with isocyanate groups in components a), b) and c) ranges from 0.95:1 to 1.15:1.

8. The process of claim 6, in which the equivalent ratio of isocyanate (NCO) groups in (B) said isocyanate component, to the sum of hydrogen atoms which can react with isocyanate groups in components a), b) and c) ranges from 0.98:1 to 1.05:1.

9. The process of claim 6, in which (B) said isocyanate component comprises a prepolymer prepared by reacting (1) 4,4′-diphenylmethane diisocyanate and/or modified 4,4′-diphenylmethane diisocyanate, with (2) a mixture comprising (a) one or more polyether polyols having an OH number of from 10 to 112, and (b) one or more polyethylene glycols and/or one or more polypropylene glycols having molecular weights of 135 g/mol to 700 g/mol.

10. The process of claim 9, in which the modified 4,4′-diphenylmethane diisocyanate additionally contains carbodiimide groups and/or allophanate groups.

11. Polyurethane articles, including shoe soles and shoe inserts, comprising the solid, filled, molded parts of claim 1.
